(19) United States
(12) Patent Application Publication
(10) Pub. No.: US 2008/0176192 A1
(43) Pub. Date: Jul. 24, 2008

(54) SHADOW COURSE HIERARCHY FOR ONLINE COURSES

(76) Inventors: Brandt Christian Redd, Provo, UT (US); James Russell Ivie, Lindon, UT (US); Mark Wolfgramm, Provo, UT (US); Brady S. Isom, Pleasant Grove, UT (US); Jeffery R. Gammon, Pleasant Grove, UT (US); Bernd Helzer, Draper, UT (US); Todd J. Hardman, Orem, UT (US); Paul Bryon Smith, Lehi, UT (US); Jiaxin Jerry Gao, Lehi, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/851,367

(22) Filed: Sep. 6, 2007

Related U.S. Application Data
(60) Provisional application No. 60/885,871, filed on Jan. 19, 2007.

(51) Int. Cl. G09B 19/00

(52) U.S. Cl. 434/118

(57) ABSTRACT

In a computing environment comprising a course authoring system connected to a server, a method for creating a hierarchy of course materials, the method comprising creating a master course comprising a plurality of course elements, storing the master course in the course authoring system, selecting elements of the master course to be copied into a shadow course, copying the selected elements of the master course into a shadow course that includes course elements which are inherited from the master course, storing the shadow course in the course authoring system, associating at least one element in the shadow course with an element of the master course, and modifying at least one element of in the shadow course, wherein any modification to a course element of the master course is automatically propagated to any course elements of the shadow course which are associated with the modified course element of the master course.

### CROSS-REFERENCE TO RELATED APPLICATIONS

This application claims priority to U.S. Provisional Application Ser. No. 60/885,871, filed on Jan. 19, 2007, and is incorporated herein by reference in its entirety.

### BACKGROUND OF THE INVENTION

1. The Field of the Invention

The present invention relates to online educational course development, and more particularly to a hierarchical course authoring environment.

2. The Relevant Technology

Curriculums are generally used during the course development process to define the scope and progression of the course, by first defining a series of learning objectives or skills that a student should master after completing the course. Using this curriculum, a strategy is then developed for teaching the student the learning objectives, typically using a series of units, wherein each unit is a portion of the curriculum which includes a number of assignments, lectures, quizzes, tests, experiments, projects, and the like.

Because of the large amount of planning and content that must be developed during this process, it generally requires a large amount of time and expertise, particularly since it may be inspected by local, state or federal institutions in order to ensure that the curriculum meets educational standards. Thus, course development is often a long and difficult process, requiring years of revisions and the gradual adjustment of the courses in response to feedback and student performance. Unfortunately, schools often lack the time or financial resources to invest in this process, meaning that the process is often prohibitively expensive to new schools or to schools interested in developing new courses.

Because of these difficulties in developing a successful curriculum, many companies and professors have begun selling their course curriculums and course content to other educators interested in quickly and inexpensively developing a new course. One disadvantage to purchasing a complete curriculum, however, is that the purchaser often loses the benefit of further modifications or updated materials. Furthermore, the curriculums are difficult to modify or individualize to fit the specific schedule or demands for every setting. Additionally, the purchaser is often required to pay for a complete course worth of materials, rather than allowing the purchaser to pick and chose which individual materials he or she would like to incorporate in a new course.

Other difficulties arise where a institution expends the expense and time to develop its own curriculum, and little additional time or funds are left to subsequently modify or adapt the curriculum beyond its initial application. Often, menial tasks such as applying a new schedule to a master curriculum or correcting simple typographical or other small errors in the course materials take up any available time or budget, meaning that the educators have little or no time remaining to spend on developing new materials that improve the content of the course. Thus, there is a need for a method for developing and maintaining course content that efficiently and inexpensively allows educators to modify and update their materials.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to systems and methods for creating a hierarchy of online educational courses in a collaborative course authoring environment.

This summary is provided to introduce a selection of concepts in a simplified form that are further described below in the Detailed Description. The summary is not intended to identify key features or essential characteristics of the claimed subject matter, nor is it intended to be used as an aid in determining the scope of the claimed subject matter. One aspect of the invention is a method for creating a hierarchy of course materials in a collaborative course authoring environment comprising a course authoring system connected to a server. The method comprises creating a master course comprising a plurality of course elements, storing the master course in the course authoring system, selecting elements of the master course to be copied into a shadow course, copying the selected elements of the master course into a shadow course that includes course elements which are inherited from the master course, storing the shadow course in the course authoring system, associating at least one element in the shadow course with an element of the master course, and modifying at least one element of in the shadow course, wherein any modification to a course element of the master course is automatically propagated to any course elements of the shadow course which are associated with the modified course element of the master course.

Another aspect of the invention is a second method for creating a hierarchy of course materials in a collaborative course authoring environment comprising a course authoring system connected to a server, a method for creating a hierarchy of course materials. The method comprises creating a master course comprising a plurality of course elements, storing the master course in the course authoring system, creating a shadow course including course elements, the course elements being references to course elements of the master course, and storing the shadow course in the course authoring system, wherein the course elements of the shadow course which are associated with course elements of the master course.

A third aspect of the invention is a system for creating a hierarchy of educational courses, comprising a plurality of user computing devices configured to connect to an course authoring system via a network connection, and a course authoring system comprising a server capable of transferring and receiving a plurality of educational information with the user computing devices, and database being configured to group the educational information as course elements in a set of master and shadow courses, wherein the shadow courses have course elements that are associated with corresponding course elements of a master course and any modification to a course element of the master course is automatically propagated by the course authoring system to update the corresponding course elements of the shadow courses.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram illustrating an exemplary system capable of performing the invention;

FIG. 2A is a block diagram illustrating an embodiment of a method for creating a shadow course in association with the invention;

FIG. 2B is a block diagram illustrating an additional embodiment of a method of creating a shadow course in association with the invention;

FIG. 3 is a block diagram illustrating the method of creating hierarchy of course materials using the invention;

FIG. 4 is a block diagram illustrating the method of receiving updated course materials using hierarchy of course materials set forth in the invention;

FIG. 5 is a block diagram illustrating one application of the invention wherein a user can create a new shadow course by selecting course elements from a collaborative course environment; and

FIG. 6 is a block diagram illustrating another application of the invention wherein a user can create a series of shadow courses for the various sections of a single master course by selecting course elements from single master course.

### DETAILED DESCRIPTION OF THE PREFERRED EMBODIMENTS

Embodiments of the invention relate to systems and methods for creating a hierarchy of course materials which may be easily and efficiently modified and updated according to the demands of a particular course. More specifically, the invention relates to a system and method for creating a hierarchy of course materials comprised of master courses and shadow courses, wherein the master courses comprise elements such as tests, lectures, projects, worksheets, quizzes, activities, games, notes, outlines, assignments, and the like, and the shadow courses are comprised of elements from the master courses. According to one aspect of the invention, the elements of the shadow course may be associated with corresponding elements in the master course such that the elements are automatically updated each time the elements in the master course are updated.

Another aspect of the invention is the ability to use the elements of the master course as a template which may be subsequently modified or altered for a particular course. Consequently, a teacher or other educator may pick and choose elements of the master course that he or she would like to use in the shadow course and receive the continuing benefit of automatic updates or corrections to those elements, while retaining the ability to make his or her own modifications to the elements in order to customize the shadow course for a subsequent semester.

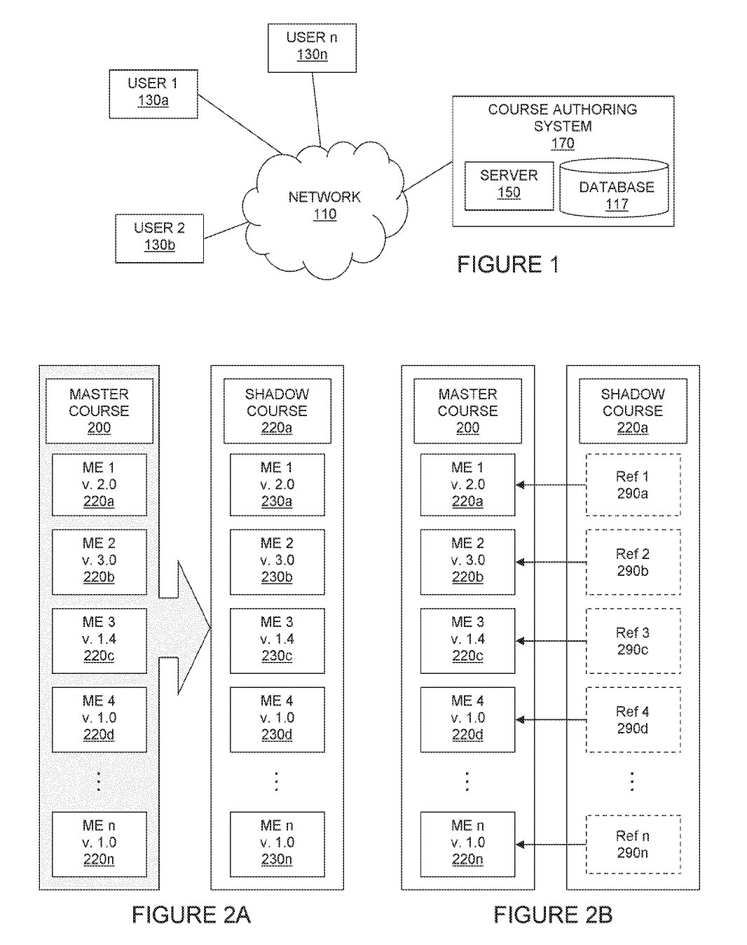

FIG. 1 is a block diagram illustrating an exemplary system capable of performing the present invention. As shown, the system includes a number of user computing devices, “User 1” 130a through “User n” 130n, which are connected to an educational management system 170 via a network connection 120. As will be understood by one of ordinary skill in the art, the network 120 may be any local or global network, including a LAN, WAN, wireless network, internet connection, and the like.

In one embodiment of the invention, the course authoring system 170 includes a server 150 capable of sending and receiving communications and data via the network 120, along with a database 160 capable of storing a plurality of educational software and data. In addition, the database 160 can be used to store data relating to the user identification. As will be understood by one of ordinary skill in the art, any number of configurations may be used to create an education system, including systems using a series of interconnected databases, computers, and servers.

Although the course authoring system 170 is illustrated as being associated with the server 150, it should be understood that in this configuration the course authoring is performed by one or more of the users 130a-130n who are connected to the system. Thus, the course content is authored remotely on the users' computing machines and then sent to the server 150 of the course authoring system 170, where it is stored and distributed to other users 130a-130n of the system 170.

Thus in one embodiment, the present invention may be implemented as an Occasionally Connected Computing system, in which the users' computers are periodically disconnected from the system 170 and the server 150. Thus, each user's computer contains a copy of all the course elements for which the user has a subscription. This allows the user 130a to continue utilizing aspects of the system regardless of his or her connectivity to the network 120. Later, when the user's computer 130a is able to connect to the server 150, the system 170 performs a sync operation wherein new or modified content is transferred between the user's computer and the server 150.

The user computing device may be any specific of general computer system that is equipped to receive, send, and process educational content. The computer may be, for example, a personal computer, portable computer, handheld device, or any other computing machine. A suitable computer system may include a modem, a monitor, a keyboard, a mouse, system software including support for TCP/IP communication, and other various types of software. Further, more than one user may connect to the course authoring system using the same computer.

As previously discussed, by using an environment such as the environment described in FIG. 1, the present invention relates to methods and systems for creating course content using a collaborative online environment. Thus, the course authoring system 170 may include a server 150 that allows users who are connected to the system to share and create educational content. Thus, a first user, “User 1” 130a may submit course materials, including a completed course and its accompanying curriculum, or any educational content to the system. Once the material is submitted, the server 150 may receive the content and store it in a database 117 where the material may be sorted, stored, and retrieved by users of the system 170.

In an embodiment of the invention, the educational content stored in the system 170 may only be available to the user who originally submitted the content for repackaging, bundling, or downloading. According to other variations that may be used in association with the invention, a user may elect to make his or her content available to other users for editing, repackaging, bundling or downloading. In that embodiment, the system may further include a repository which collects content from users which can be grouped together by topic, course, geography, education level, and the like in order to create a searchable database of content that is available to users. Further, the content may be available based on a paid subscription, payment to the content author, and the like.

Optionally, the course authoring system may include different authorization levels associated with the course materials such that some materials may only be modified by a set of users, which may include the author of the course materials and/or a system administrator.

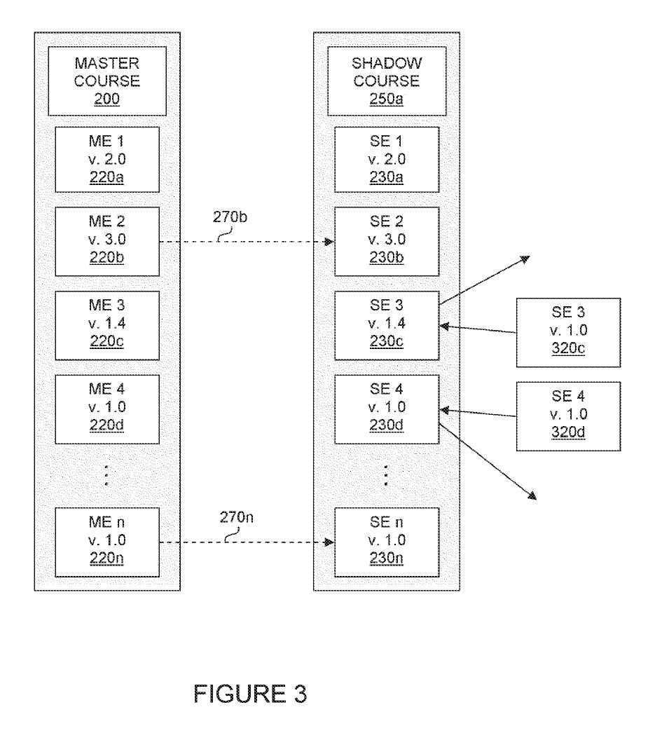

FIGS. 3-6 are block diagrams illustrating an embodiment of the invention where the shadow course is created by copying elements of the master course into the shadow course as shown in FIG. 2A. Thus, each time a course element 220a of the master course 200 is included in a shadow course 220a, the system creates a copy of the course element and stores the course element 230a-230n within the shadow course 220a. The course elements 230a-230n in the shadow course 220a may be automatically updated in association with the master course elements 220a-220n using the method described more fully below.

Alternatively, another embodiment of the invention, shown in FIG. 2B may be used wherein the shadow course 220a is created by creating references 290a-230n or pointers which refer to an associated course element 220a-220n in the master course 200. One advantage of this implementation is that there is no need to store multiple copies of the same file within the system. Each time a master course element 220a-220n is modified, the changes will automatically be reflected in the shadow course 220a when the references 290a-290n retrieve the most recent version of the master course element 220a-220n. Thus, the configuration shown FIGS. 3-6 are meant to be illustrative only. As understood by one of ordinary skill in the art, many different configurations and methods for storing and updating data may be used in association with the present invention, and the configuration described with reference to the Figures are meant to be illustrative only and should not be construed to limit the scope of the claims.

FIG. 2A is a block diagram illustrating a method for creating a hierarchy of course materials according to the invention. Here, the course materials are shown as a completed master course 200 comprised of a plurality of course elements 220a-220n. Each course element 220a-220n includes a revision number, such as version “v. 2.0” shown in the first master course element 220a. In this example, the invention will be described in a collaborative environment, where the master course 220 is submitted by a first user 130a wherein a second user 130b is permitted to use the system 170 to create a shadow course 250a from the first user's 130a master course 200.

The master course 200 shown in FIG. 2 is a complete course curriculum comprised of elements 220a-220n. As understood by one of ordinary skill in the art, the invention may also be used where the master course 200 is not a completed course curriculum, but is a collection of education content that has been created by a user 130a of the system 170 that a second user 130b desires to use to create a shadow course 250a.

As shown in FIG. 2, the shadow course 250a is created by copying the course elements 220a-220n of the master course 200 into a plurality of course elements 230a-230n of the shadow course 250a. As described more fully below, one aspect of the invention is the ability to associate the course elements of the shadow course with the master course, such that when the course elements are updated in the master course, the modifications will automatically be propagated to the elements in the shadow course.

FIG. 3 is a block diagram which illustrates a user's ability to modify course elements 230a-230n of the shadow course 250a. As shown in FIG. 3, the shadow course 250a initially includes course elements 230a-230n which are duplicates of the course elements 220a-220n of the master course 200. During the course making process, however, the user 130b may modify or replace the course elements 230a-230n in order to create a individualized or customized shadow course. Here, the master course element “ME 3” 230c is replaced with a new shadow course element “SE 3: 320c. Optionally, the user may also be able to make modification to the master course elements. In one embodiment, when course element “ME 4” 230d is modified, the system 170 replaces the course element “ME 4” 230d with a shadow course element “SE 4” 320d, which is the master course element “ME 4” 220d with the user's changes.

According to one aspect of the invention, the user may elect to continue to receive updated versions of course elements 220a-220n from the master course 200 by associating the shadow course elements 230a-230n with the master course elements 220a-220n. In FIG. 3, the associations are shown as arrows 270b and 270n. According to one embodiment, any modification to the course elements 220a-220n of the shadow course which have been copied from the master course 200 will sever the association and those course elements 320c and 320d of the shadow course 220a will no longer receive updated versions of the updated master course elements 230c and 230d. In FIG. 3, the shadow course 220a is shown with remaining associations 270b and 270n, meaning that any updated versions of master course elements 220b and 220n will be automatically propagated to shadow course elements 230b and 230n.

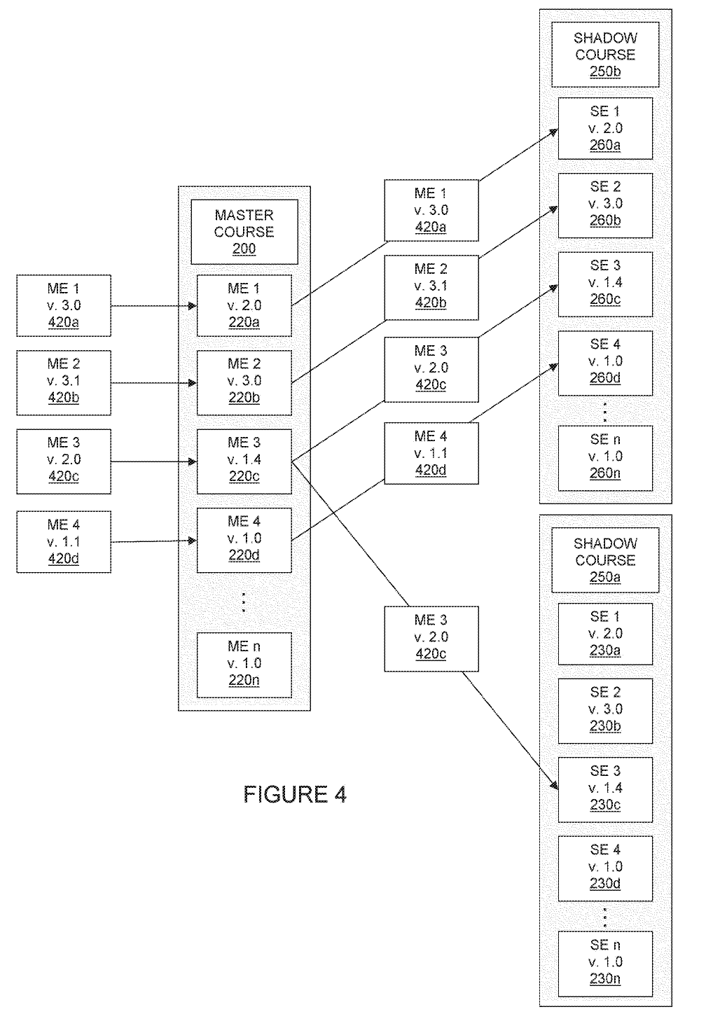

FIG. 4 is a block diagram illustrating the automatic propagation process according to the invention. Here, a master course 200 is shown which includes course elements 220a-220n. Using the process described above, users of the course authoring system have created two shadow courses 250a and 250b. Shadow course 250a is the same shadow course described in FIGS. 2 and 3, meaning that it is associated with the master course 200 such that any updates to master course elements 220b and 220n will be automatically populated to shadow course elements 230b and 230n. Similarly, shadow course 250b is associated with the master course such that any updates to master course elements 220a-220d will be automatically populated to course elements 260a-260d.

In the example shown in FIG. 4, a first user 130a with the ability to modify the master course 200 has sent the system 170 updated versions 420a-420d of course elements 220a-220d. Upon receiving the updated course elements 420a-420d, the system 170 searches through the various shadow courses 250a and 250b with associated course elements 260a-260d and 230c and sends each of the associated shadow courses 250a and 250b the updated versions of the course elements 420a-d.

Other features or characteristics of the system may be altered or added without modifying the scope or utility of the invention. For instance, the user who created the shadow courses may have the ability to review the updated course elements before adopting the changes in his or her shadow course. If the user elects not to receive the updated course elements, then the system may disassociate the shadow course elements and save a copy of the unmodified course elements in the shadow course.

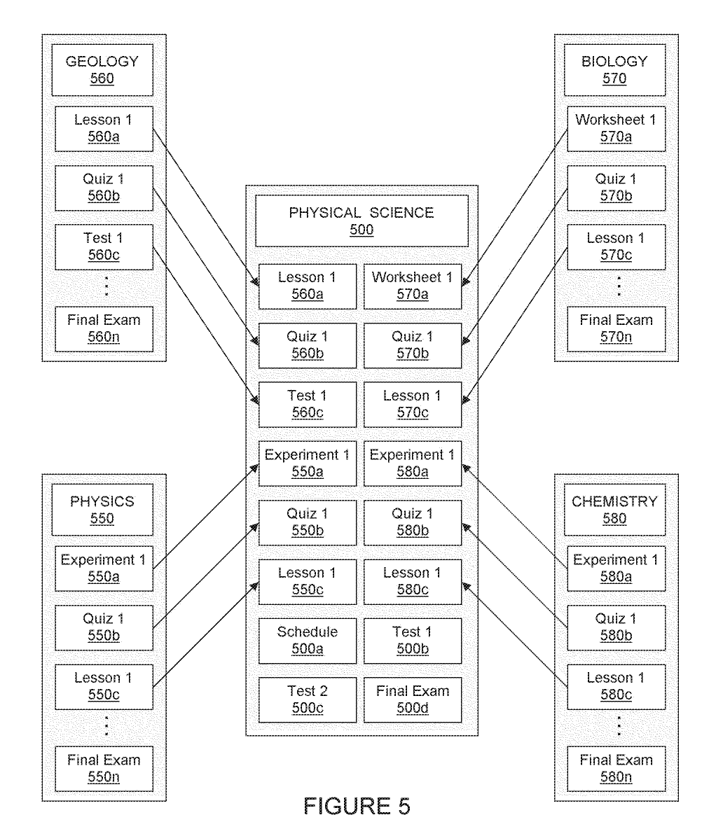

FIG. 5 is a block diagram illustrating an application of the invention in a situation where a user of the course authoring system wants to create a new course by searching and regrouping course elements from courses which have been previously submitted to the system. Here, the user is developing a physical science course 500. Traditionally, the user would be required to either develop all the materials by himself, which is time and cost intensive, or he would have to purchase a complete curriculum for the subject. By using the invention disclosed above, he is able to select course elements from a variety of courses in order to create a customized course that is suitable for his needs.

Here, the course is a physical science course 500 that the user has determined should include an introductory overview of geology, physics, biology and chemistry. Instead of purchasing an existing curriculum, the user may select individual course elements from a geology course 560, a biology course 570, a physics course 550, and a chemistry course 580 in order to create the user's own physical science course 500. Thus, as illustrated in FIG. 5, the user may select individual elements from a variety of courses, including worksheets, quizzes, lesson, tests, experiments, and the like. This allows the user to pick and chose elements that are the most illustrative and effective as teaching tools.

As previously mentioned, one advantage of the present invention is that the user is still able to receive updated versions of each individual course element, enabling the user to receive simple administrative or typographical changes to the material without spending a large amount of time or resources correcting all his course materials. Further, this allows the user to add his own elements to the physical science course without interfering with the other course elements. Here, the physical science course includes course elements 560a-c which are associated with the geology course 560, course elements 570a-c which are associated with the biology course 570, course elements 550a-c which are associated with the physics course 550, course elements 580a-c which are associated with the chemistry course 580, along with course elements 500a-d which have been created by the user and added to the physical science course 500.

Thus, one aspect of the invention is an effective and efficient course authoring system and method that allows a user to take from previously created materials to create a hierarchy of course materials that are easily modified and updated in order to create a customized course.

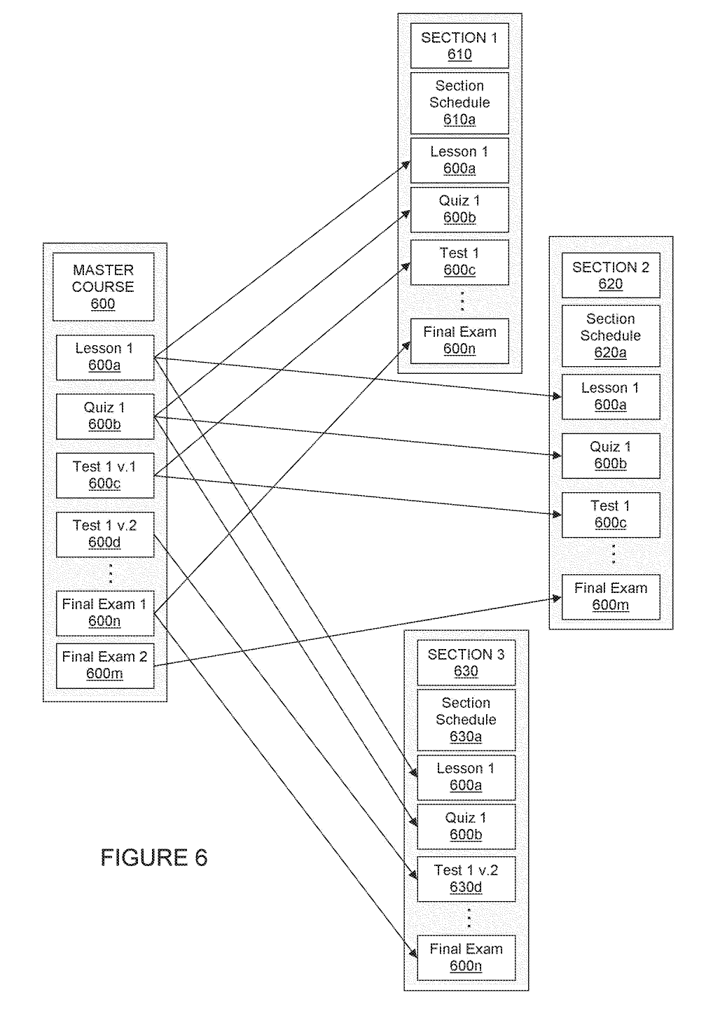

FIG. 6 is a diagram that illustrates application of the invention where a user is able to take a single master course to create a series of shadow courses which may be used for the various sections 610, 620, and 630 of the course. Often in the college setting, a professor may be required to alter the schedule or content of a course to fit with the specific demands of a particular course. For instance, a single master course 600 may need to be modified to fit a shortened schedule, meaning that the user may desire to exclude some elements of the course. Alternatively, the user may desire to use different exams for the different sections in order to discourage students of the various sections from discussing exam questions between the administration of each section's exam. Traditionally, this would require the user to keep track of each variation of the course, altering or copying the materials to fit each specific section.

Using the invention, the user is able to include various elements of the master course 600 into the Section 1 course 610. The Section 2 course 620, is given a different final exam 620m, and the Section 3 course 630 is given a different Test 1 600d. By storing all the course materials in a single master course 600, the user has a central location to store and modify all the course elements 600a-600m, which then are automatically updated in each of the various sections 610, 620, and 630.

Thus another aspect of the invention is the ability to effectively control and distribute the various revisions of his or her work. By using the master course and the hierarchy described above, the user may easily distribute and update all of his or her course materials without spending a large amount of time going through the various documents.

The embodiments described herein may include the use of a special purpose or general-purpose computer including various computer hardware or software modules, as discussed in greater detail below.

Embodiments within the scope of the present invention also include computer-readable media, recordable-type media, or physical storage media for carrying or having computer-executable instructions or data structures stored thereon. Such computer-readable media, recordable-type media, or physical storage media can be any available media that can be accessed by a general purpose or special purpose computer. By way of example, and not limitation, such computer-readable media, recordable-type media, or physical storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable, recordable-type media, or physical storage medium. Thus, any such connection is properly termed a computer-readable medium. Combinations of the above should also be included within the scope of computer-readable media, recordable-type media, or physical storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment for collaborative course authoring comprising a course authoring system connected to a server, a method for creating a hierarchy of course materials, the method comprising:
creating a master course comprising a plurality of course elements;
storing the master course in the course authoring system;
selecting elements of the master course to be copied into a shadow course;
copying the selected elements of the master course into a shadow course that includes course elements which are inherited from the master course;
storing the shadow course in the course authoring system;
associating at least one element in the shadow course with a corresponding element of the master course; and
modifying at least one element of in the master course,
wherein any modification to a course element of the master course is automatically propagated to any corresponding course elements of the shadow course.

2. The method according to claim 1, wherein the course elements are selected from a list comprising at least one of assignments, quizzes, tests, projects, presentations, worksheets, games, puzzles, lectures, and outlines.

3. The method according to claim 1, wherein course authoring system is connected to a first and second user computing device and the master course is created on a first user computing device and the shadow course is created on a second user computing device.

4. The method according to claim 1, wherein the master course and shadow course are each created using on a single user computing device connected to the course authoring system.

5. The method according to claim 1, wherein selecting elements of the master course to be copied into a shadow course comprises selecting elements from more than one master course to be copied into a shadow course, and copying the selected elements of the master course into a shadow course comprises copying the selected elements of the more than one master course into the shadow course.

6. The method according to claim 1, further comprising creating at least one element of in the shadow course which is not associated with any corresponding element of the master course.

7. The method according to claim 1, wherein a course element from a master course may be selected for copying and copied into more than one shadow course and associated with elements of the more than one shadow course such that an modification to the course element of the master course is automatically propagated to each corresponding course element in the more than one shadow course.

8. In a computing environment for collaborative course authoring comprising a course authoring system connected to a server, a method for creating a hierarchy of course materials, the method comprising:
creating a master course comprising a plurality of course elements;
storing the master course in the course authoring system;
creating a shadow course including course elements, the course elements being references to course elements of the master course; and
storing the shadow course in the course authoring system,
wherein the course elements of the shadow course which are associated with course elements of the master course.

9. The method according to claim 8, wherein the course elements of the master course are selected from a list comprising at least one of assignments, quizzes, tests, projects, presentations, worksheets, games, puzzles, lectures, and outlines.

10. The method according to claim 8, wherein course authoring system is connected to a first and second user computing device and the master course is created on a first user computing device and the shadow course is created on a second user computing device.

11. The method according to claim 8, wherein the master course and shadow course are each created using on a single user computing device connected to the course authoring system.

12. The method according to claim 8, wherein creating a shadow course including course elements comprises including course elements from more than one master course.

13. The method according to claim 8, further comprising creating at least one element of in the shadow course which is a reference to a course element of the master course.

14. A system for creating a hierarchy of educational courses, the system comprising:
a plurality of user computing devices configured to connect to an course authoring system via a network connection; and
an course authoring system comprising a server capable of transferring and receiving a plurality of educational information with the user computing devices, and database being configured to group the educational information as course elements in a set of master and shadow courses;
wherein the shadow courses have course elements that are associated with corresponding course elements of a master course and any modification to a course element of the master course is automatically propagated by the course authoring system to update the corresponding course elements of the shadow courses.

15. The system according to claim 14, wherein the course elements are selected from a list comprising at least one of assignments, quizzes, tests, projects, presentations, worksheets, games, puzzles, lectures, and outlines.

16. The system according to claim 14, wherein course authoring system is connected to a first and second user computing device and the master course is created on a first user computing device and the shadow course is created on a second user computing device.

17. The system according to claim 14, wherein the master course and shadow course are each created using on a single user computing device connected to the course authoring system.

18. The system according to claim 14, wherein a course element of the shadow course which is associated to a course element of the master course comprises a reference or pointer to the location of the course element of the master course.

19. The system according to claim 14, wherein a course element of the shadow course which is associated to a course element of the master course comprises an additional copy of the master course element which is automatically updated when the associated course element in the master course is modified.

20. The system according to claim 14, wherein the system is an occasionally connected computing system, wherein the user computing devices are periodically disconnected from the course authoring system and the computing devices are capable of storing and utilizing the course materials when the computing device is not connected to the course authoring system.
